(19) United States
(12) Patent Application Publication
(10) Pub. No.: US 2015/0228431 A1
(43) Pub. Date: Aug. 13, 2015

(54) ELECTROMAGNETIC RELAY

(71) Applicant: NEC TOKIN Corporation, Sendai-shi (JP)

(72) Inventors: Yuta SUZUKI, Sendai-shi (JP); Yoshinori OTA, Sendai-shi (JP); Tsutomu ONO, Sendai-shi (JP)

(21) Appl. No.: 14/614,820

(22) Filed: Feb. 5, 2015

(30) Foreign Application Priority Data
Feb. 13, 2014 (JP) 2014-025285

(51) Int. Cl. H01H 50/54

(52) U.S. Cl. CPC H01H 50/54

(57) ABSTRACT

In an electromagnetic relay 1, the entire circumference 30a of a normally-opened fixed contact 30 and the entire circumference 40a of the normally-closed fixed contact 40 extend beyond movable contacts 25 on a plane roughly perpendicular to the moving direction P of the movable contacts 25. In other words, when the electromagnetic relay 1 is viewed from a movable leaf spring 20 side, all of normally-opened side movable contacts 25a and normally-closed side movable contacts 25b are located within an area surrounded by the entire circumference 30a of the circular normally-opened fixed contact 30 and the entire circumference 40a of the circular normally-closed fixed contact 40. Further, while the number of the movable contacts 25 is two or more, the number of the normally-opened fixed contact 30 and the number of the normally-closed fixed contact 40 are both one.

### INCORPORATION BY REFERENCE

This application is based upon and claims the benefit of priority from Japanese patent application No. 2014-025285, filed on Feb. 13, 2014, the disclosure of which is incorporated herein in its entirety by reference.

### BACKGROUND OF THE INVENTION

1. Field of the Invention

The present invention relates to an electromagnetic relay.

2. Description of Related Art

Japanese Unexamined Patent Application Publication No. 2011-81961 discloses a related art (hereinafter referred to as “Patent Literature 1”). An electromagnetic relay disclosed in Patent Literature 1 includes a cover, a base block that closes the bottom of the cover, an electromagnet incorporated into the base block, a movable leaf spring driven by the electromagnet, movable contacts disposed at the tip of the movable leaf spring, and a normally-opened fixed contact and a normally-closed fixed contact disposed to be opposed to each other with the movable contacts interposed therebetween. A slit is formed in the movable leaf spring and the movable leaf spring is divided into a pair or left and right pieces by the slit. Further, a movable contact is provided in each of the left and right divided pieces. To conform to this, each of the normally-opened fixed contact and normally-closed fixed contact is also divided into two sections. Therefore, one movable contact, and one normally-opened fixed contact and one normally-closed fixed contact are provided on each of the left and right sides.

### SUMMARY OF THE INVENTION

However, the present inventors have found the following problem. In the above-described electromagnetic relay in the related art, the normally-opened fixed contacts or the normally-closed fixed contacts are arranged side by side with a gap formed therebetween. Therefore, there is a high possibility that foreign objects come into the gap between the pair of left and right normally-opened fixed contacts or left and right normally-closed fixed contacts when the electromagnet is manufactured or used. Further, when foreign objects come into the gap, poor connection tends to occur. Further, when the heights of the left and right contacts of the normally-opened fixed contacts and/or the normally-closed fixed contacts are different from each other, poor connection tends to occur. In particular, the contacts of compact electromagnetic relays are very small. Therefore, a small foreign object (or a small amount of foreign objects) could have a significant influence on the reliability of the connection between contacts.

An object of the present invention is to provide an electromagnetic relay having improved reliability for the connection between contacts.

A first exemplary aspect of the present invention is an electromagnetic relay including:
a plurality of movable contacts disposed in a movable leaf spring driven by an electromagnet; and
a normally-opened fixed contact and a normally-closed fixed contact disposed to be opposed to each other with the movable contacts interposed therebetween, in which
an entire circumference of the normally-opened fixed contact and an entire circumference of the normally-closed fixed contact extend beyond the movable contacts on a plane roughly perpendicular to the moving direction of the movable contacts,
a plurality of divided pieces divided by a slit extending from a tip of the movable leaf spring are disposed in the movable leaf spring, and each of the movable contacts is disposed in a respective one of the divided pieces, and
the number of the normally-opened fixed contact and the number of the normally-closed fixed contact are both one while the number of the movable contacts is two or more for the plane.

In this electromagnetic relay, each of the movable contacts is disposed in a respective one the divided pieces of the movable leaf spring, and the entire circumference of the normally-opened fixed contact and the entire circumference of the normally-closed fixed contact extend beyond the movable contacts on the plane roughly perpendicular to the moving direction of the movable contacts. Further, the number of the normally-opened fixed contact and the number of the normally-closed fixed contact are both one while the number of the movable contacts is two or more for the plane roughly perpendicular to the moving direction of the movable contacts. With this configuration, the situation in which a foreign object enters the normally-opened fixed contact side or the normally-closed fixed contact side in production or in use is prevented. Further, even if a foreign object is caught between one of the movable contacts and the normally-opened fixed contact or the normally-closed fixed contact, the other movable contact(s) comes into contact with the normally-opened fixed contact or the normally-closed fixed contact. Therefore, the electrical conduction can be maintained and the reliability of the connection between contacts can be improved. Further, the number of the normally-opened fixed contact and the number of the normally-closed fixed contact are both only one. Therefore, the alignment process between the normally-opened fixed contact and the normally-closed fixed contact can be easily carried out and the effect of dimension errors can be reduced. Further, the contact areas of the normally-opened fixed contact and the normally-closed fixed contact are large. Therefore, there is another advantageous effect that poor contact with movable contacts is less likely to occur.

Further, a bending section that is formed by bending the movable leaf spring near the movable contacts in a crank shape is disposed in part of the divided pieces of the movable leaf spring. An armature is fixed in the movable leaf spring so as to be opposed to the electromagnet and an end of this armature is disposed near the bending section.

With this configuration, the armature can be located near the normally-opened fixed contact or the normally-closed fixed contact. Therefore, the gap between the armature and the normally-opened fixed contact or the normally-closed fixed contact can be narrowed, thus making it possible to prevent the situation in which a foreign object enters through that gap.

Further, a cut-out section that extends in a direction roughly perpendicular to the extending direction of the slit near an end of the slit is formed in the movable leaf spring.

By employing the cut-out section, the spring constant of each divided piece can be easily lowered, thus enabling each divided piece to bend more easily. As a result, the response of the connection between contacts can be improved.

Further, the movable contacts are welded to the movable leaf spring.

By welding the movable contacts to the movable leaf spring, the thickness of the movable contacts can be reduced compared to the case where the movable contacts are connected to the movable leaf spring by calking as in the case of Patent Literature 1. As a result, since the gap between the normally-opened fixed contact and the normally-closed fixed contact can be narrowed, the situation in which a foreign object enters through that gap can be further prevented.

Further, the movable contact includes a normally-opened side movable contact located on the normally-opened fixed contact side and a normally-closed side movable contact located on the normally-closed fixed contact side. A position of the normally-opened side movable contact and a position of the normally-closed side movable contact are shifted from each other in the extending direction of the slit.

When the movable contacts are welded to the movable leaf spring, the welding strength and the workability are improved by securing empty space on the back surfaces of the movable contacts. Therefore, the positions of the normally-opened side movable contact and the normally-closed side movable contact are preferably shifted from each other in the extending direction of the slit.

The movable contacts slide in the extending direction of the slit when they come into contact with the normally-opened fixed contact or the normally-closed fixed contact. Since the movable contacts and the normally-opened fixed contact or the normally-closed fixed contact slide, the contact points through which actual electrical conduction occur move. Even when a certain contact point cannot secure electrical conduction due to an insulating foreign object, an insulating film, or the like, there is possibility that another contact point can secure electrical conduction because the contact points move by the sliding. Further, there is possibility that the sliding action can eliminate foreign objects. Note that since the fixed contacts have large surfaces, a large area contributing to the contact is secured, thus providing an advantage for the electrical conduction. In particular, when the long sides of the contact surfaces of the movable contacts extend in a direction perpendicular to the extending direction of the slit, this advantageous effect increases even further.

According to the present invention, the reliability of the connection between contacts can be improved.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a plan view showing an exemplary embodiment of an electromagnetic relay according to the present invention;

FIG. 2 is a cross section taken along a line II-II in FIG. 1;

FIG. 3 is a cross section taken along a line III-III in FIG. 1; and

FIG. 4 is a perspective view showing a base and a movable leaf spring.

### DESCRIPTION OF THE EXEMPLARY EMBODIMENTS

Preferable exemplary embodiments of an electromagnetic relay according to the present invention are explained hereinafter with reference to the drawings.

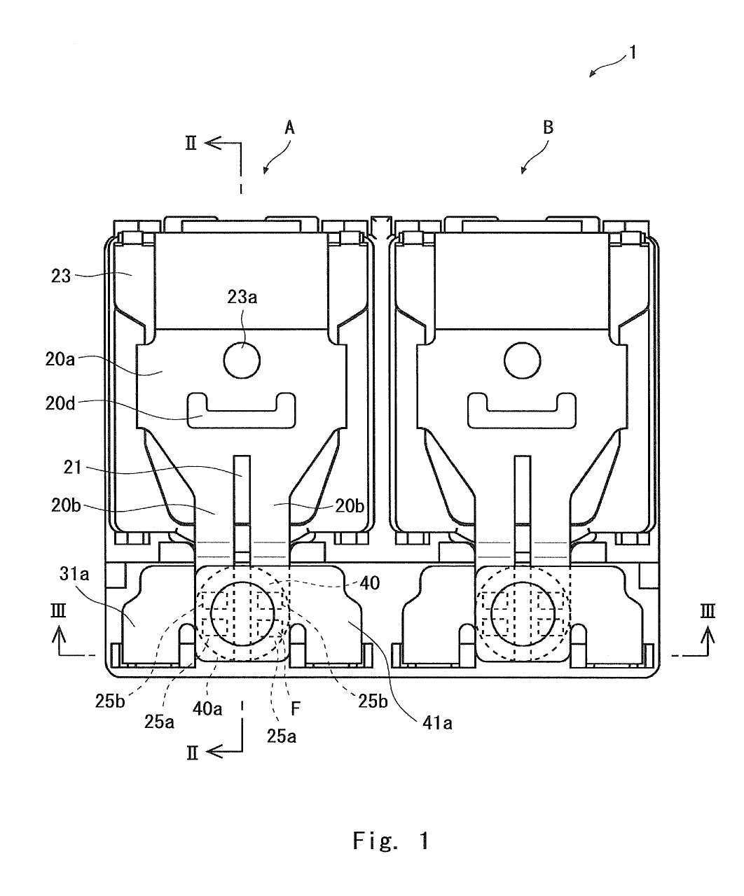

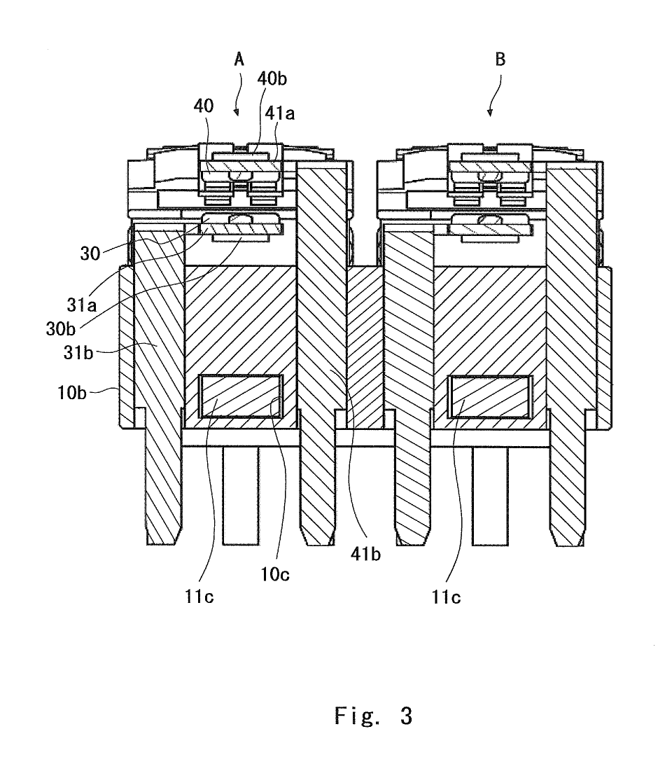

As shown in FIGS. 1 to 3, an electromagnetic relay 1 is an electrical component installed in a car, and formed in a compact size. A pair of left and right relay sections A and B are arranged side by side inside a housing 2 of the electromagnetic relay 1. Further, the relay sections A and B are both fixed to a base 10 disposed on an opened side of the housing 2. The relay sections A and B perform switching operations independently of each other. The relay sections A and B have identical configurations to each other. Therefore, the configuration of only the relay section A is explained in detail hereinafter.

In the relay section A, a yoke 11 having an L-shape in cross-section is fixed to the base 10, and a coil bobbin 12 is fixed to the yoke 11. A coil 13 is wound on the coil bobbin 12.

Further, a cylindrical iron core 14 is inserted in a through-hole 12a formed at the center of the coil bobbin 12. Further, the yoke 11, the coil bobbin 12, and the iron core 14 are integrally fixed by a calking section 14b located at the tip of the iron core 14, thus forming an electromagnet 15. Then, by feeding electricity through the coil 13, a magnetic force is generated.

A movable leaf spring 20 is disposed to be opposed to a circular head 14a of the iron core 14. This movable leaf spring 20 is composed of a main body section 20a and divided pieces 20b. The main body section 20a is opposed to the head 14a, and the divided pieces 20b extend from an end of the main body section 20a and are divided into the two pieces by a slit 21. Further, movable contacts 25 are provided on the tip side of each divided piece 20b. Further, a lead section 22 is integrally formed by bending in the main body section 20a of the movable leaf spring 20. The lead section 22 extends from an end of the movable leaf spring 20 perpendicularly to the movable leaf spring 20 and is fixed to the yoke 11 by a calking section 11b provided in an upright piece 11a of the yoke 11.

A plate-like armature 23 made of magnetic material is fixed to the main body section 20a of the movable leaf spring 20 by a calking section 23a. A plate-like armature 23 is disposed to be opposed to the head 14a of the iron core 14. The head 14a of the iron core 14 is magnetically coupled to the armature 23 by the magnetic force of the electromagnet 15. Further, when the magnetic force of the electromagnet 15 is un-energized, the armature 23 moves away from the head 14a of the iron core 14 and raises the divided piece 20b upward by the spring force of the movable leaf spring 20.

The base 10, to which the electromagnet 15 is fixed, is composed of a base main body 10a disposed on the opened side of the housing 2 and an upright section 10b disposed at an end of the base main body 10a. An opening 10c extending in a direction perpendicular to the central axis line L of the iron core 14 is formed in this upright section 10b, and the tip side of a placement section 11c of the yoke 11 is inserted into this opening 10c. Further, a first terminal 31 in which a normally-opened fixed contact (so-called make contact) 30 is provided and a second terminal 41 in which a normally-closed fixed contact (so-called brake contact) 40 is provided are fixed to the upright section 10b.

The first terminal 31 is composed of a pedestal section 31a to which the normally-opened fixed contact 30 is fixed by a calking section 30b, and a lead section 31b extending perpendicularly to the pedestal section 31a. Similarly, the second terminal 41 is composed of a pedestal section 41a to which the normally-closed fixed contact 40 is fixed by a calking section 40b, and a lead section 41b extending perpendicularly to the pedestal section 41a. Further, each of the lead sections 31b and 41b is inserted into and fixed to the upright section 10b of the base 10.

The normally-opened fixed contact 30 and the normally-closed fixed contact 40, each of which has a disk shape, are disposed to be opposed to each other with the movable contacts 25 interposed therebetween in the vertical direction (i.e., in the moving direction P of the movable contacts 25 (more strictly, in the extending direction of the central axis line L of the iron core 14)). Further, each of the movable contact 25 includes a normally-opened side movable contact 25a located on the normally-opened fixed contact 30 side and a normally-closed side movable contact 25b located on the normally-closed fixed contact 40 side. Further, the positions of the normally-opened side movable contact 25a and the normally-closed side movable contact 25b are shifted from each other in the extending direction of the slit 21.

Since the normally-opened side movable contact 25a and the normally-closed side movable contact 25b are welded to the movable leaf spring 20, the thickness of the movable contacts 25 can be reduced. As a result, it is possible to reduce the gap between the normally-opened fixed contact 30 and the normally-closed fixed contact 40, thus making the penetration of foreign objects through that gap more unlikely. Further, in order to secure empty space on the back surfaces of the normally-opened side movable contact 25a and the normally-closed side movable contact 25b to ensure the welding strength and facilitate the workability, the normally-opened side movable contact 25a and the normally-closed side movable contact 25b are disposed so that their positions are shifted from each other in the extending direction of the slit 21.

The normally-opened side movable contacts 25a are disposed in and fixed to their respective divided pieces 20b so that they are disposed side by side. Similarly, the normally-closed side movable contacts 25b are also disposed in and fixed to their respective divided pieces 20b so that they are disposed side by side. The normally-opened side movable contacts 25a are fixed on the back side of their respective divided pieces 20b, while the normally-closed side movable contacts 25b are fixed on the front side of their respective divided pieces 20b. Further, the normally-opened side movable contacts 25a are located on the tip side of the divided pieces 20b and the normally-closed side movable contacts 25b are located on the rear side of the divided pieces 20b.

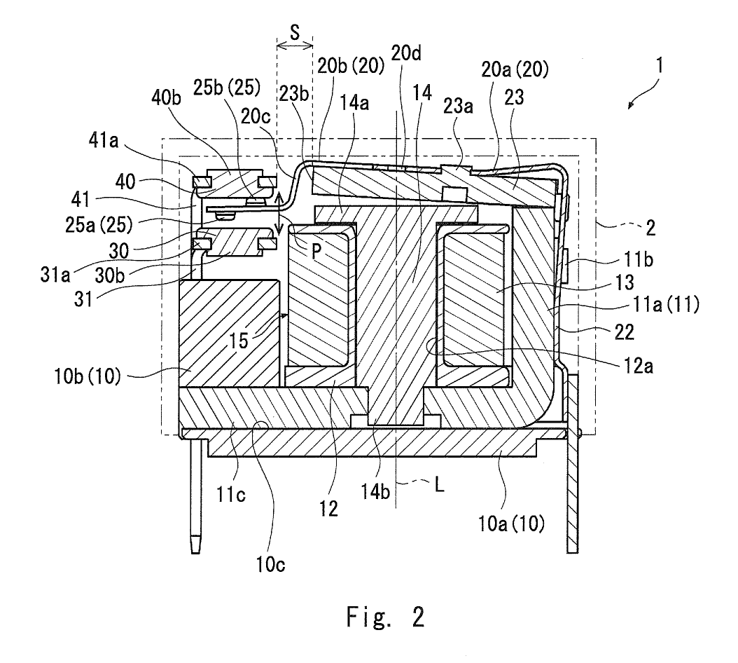

The circular entire circumference 30a of the normally-opened fixed contact 30 and the circular entire circumference 40a of the normally-closed fixed contact 40 extend beyond the movable contacts 25 on a plane that is roughly perpendicular to the moving direction P of the movable contacts 25 (more strictly, in the extending direction of the central axis line L of the iron core 14) (see FIG. 2). In other words, when the electromagnetic relay 1 is viewed from the movable leaf spring 20 side, all of the normally-opened side movable contacts 25a and normally-closed side movable contacts 25b are located within an area surrounded by the entire circumference 30a of the circular normally-opened fixed contact 30 and the entire circumference 40a of the circular normally-closed fixed contact 40. Further, while the number of the movable contacts 25 is two or more (e.g., four), the number of the normally-opened fixed contact 30 and the number of the normally-closed fixed contact 40 are both one.

In the electromagnetic relay 1 having the above-described configuration, since each of the normally-opened fixed contact 30 and the normally-closed fixed contact 40 is not divided into left and right sections and have a large size, the situation in which a foreign object enters the normally-opened fixed contact 30 side or the normally-closed fixed contact 40 side is prevented when the electromagnetic relay 1 is manufactured or used. Further, even if a foreign object is caught between one of the movable contacts 25 and the normally-opened fixed contact 30 or the normally-closed fixed contact 40, the other movable contact(s) 25 comes into contact with the normally-opened fixed contact 30 or the normally-closed fixed contact 40. Therefore, the electrical conduction can be maintained and the reliability of the connection between contacts can be improved. Further, the number of the normally-opened fixed contact 30 and the number of the normally-closed fixed contact 40 are both only one. Therefore, the alignment process between the normally-opened fixed contact 30 and the normally-closed fixed contact 40 can be easily carried out and the effect of dimension errors can be reduced. Further, the contact areas of the normally-opened fixed contact 30 and the normally-closed fixed contact 40 are large. Therefore, there is another advantageous effect that poor contact with movable contacts 25 is less likely to occur.

As shown in FIG. 1, a bending section 20c that is formed by bending the movable leaf spring 20 near the movable contacts 25 in a crank shape is disposed in part of each divided piece 20b of the movable leaf spring 20. This bending section 20c is formed by a bending process, and an end 23b of the armature 23 is located near this bending section 20c. With this configuration, the armature 23 can be located near the normally-closed fixed contact 40, in particular, near the pedestal section 41a. Therefore, the gap S between the armature 23 and the pedestal section 41a can be narrowed, thus making it possible to prevent the situation in which a foreign object enters through the gap S.

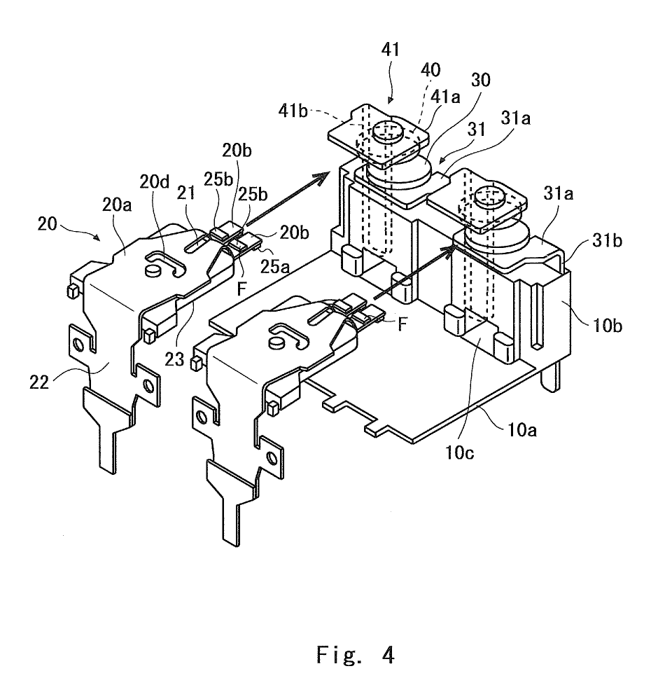

As shown in FIGS. 1 and 4, a cut-out section 20d that extends in a direction roughly perpendicular to the extending direction of the slit 21 near an end of the slit 21 is formed in the main body 20a of the movable leaf spring 20. This cut-out section 20d is formed between an end of the slit 21 and the calking section 23a of the armature 23, and is formed in a U-shape. By employing the above-described cut-out section 20d, the spring constant of each divided piece 20b can be easily lowered, thus enabling each divided piece 20b to bend more easily. As a result, the response of the connection between contacts can be improved.

The movable contacts 25 slide in the extending direction of the slit 21 when they come into contact with the normally-opened fixed contact 30 or the normally-closed fixed contact 40. Since the movable contacts 25 and the normally-opened fixed contact 30 or the normally-closed fixed contact 40 slide, the contact points through which actual electrical conduction occur move. Even when a certain contact point cannot secure electrical conduction due to an insulating foreign object, an insulating film, or the like, there is possibility that another contact point can secure electrical conduction because the contact points move by the sliding. Further, there is possibility that the sliding action can eliminate foreign objects. Note that since the fixed contacts have large surfaces, a large area contributing to the contact is secured, thus providing an advantage for the electrical conduction. In particular, when the long sides of the contact surfaces F of the movable contacts 25 extend in a direction perpendicular to the extending direction of the slit 21, this advantageous effect increases even further.

The relay section A has been explained so far. Since the relay section B has a similar configuration, its explanation is omitted. Further, a pair of the left and right relay sections A and B are arranged side by side in the housing 2 of the electromagnetic relay 1, and the relay sections A and B can perform switching operations independently of each other.

The present invention is not limited to the above-described exemplary embodiments, and the below-shown various modifications can be made without departing from the scope and spirit of the present invention.

For example, the present invention can be applied to cases where the number of the relay sections may be one or to cases where the number of the relay sections may be two or more.

Further, the shape of the normally-opened fixed contact 30 and the normally-closed fixed contact 40 is not limited to circular shapes. For example, they may have rectangular shapes.

The positions of the normally-opened side movable contact 25a and the normally-closed side movable contact 25b may not be shifted from each other in the extending direction of the slit 21 and may be shifted in the moving direction P of the movable contacts 25 (more strictly, in the extending direction of the central axis line L of the iron core 14). In this case, the outer shape of the normally-opened fixed contact 30 and the normally-closed fixed contact 40 can be reduced.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An electromagnetic relay comprising:
a plurality of movable contacts disposed in a movable leaf spring driven by an electromagnet; and
a normally-opened fixed contact and a normally-closed fixed contact disposed to be opposed to each other with the movable contacts interposed therebetween, wherein
an entire circumference of the normally-opened fixed contact and an entire circumference of the normally-closed fixed contact extend beyond the movable contacts on a plane roughly perpendicular to the moving direction of the movable contacts,
a plurality of divided pieces divided by a slit extending from a tip of the movable leaf spring are disposed in the movable leaf spring, and each of the movable contacts is disposed in a respective one of the divided pieces, and
the number of the normally-opened fixed contacts and the number of the normally-closed fixed contacts are both one while the number of the movable contacts is two or more for the plane.

2. The electromagnetic relay according to claim 1, wherein
a bending section that is formed by bending the movable leaf spring near the movable contacts in a crank shape is disposed in part of the divided piece of the movable leaf spring, and
an armature is fixed in the movable leaf spring so as to be opposed to the electromagnet and an end of this armature is disposed near the bending section.

3. The electromagnetic relay according to claim 1, wherein a cut-out section extending in a direction roughly perpendicular to the extending direction of the slit near an end of the slit is formed in the movable leaf spring.

4. The electromagnetic relay according to claim 1, wherein the movable contacts are welded to the movable leaf spring.

5. The electromagnetic relay according to claim 4, wherein
the movable contact comprises a normally-opened side movable contact located on the normally-opened fixed contact side and a normally-closed side movable contact located on the normally-closed fixed contact side, and
a position of the normally-opened side movable contact and a position of the normally-closed side movable contact are shifted from each other in the extending direction of the slit.

6. The electromagnetic relay according to claim 1, wherein the movable contact comprises a contact surface whose long side extends in a direction perpendicular to the extending direction of the slit.
